(19) United States
(12) Patent Application Publication
(10) Pub. No.: US 2011/0012943 A1
(43) Pub. Date: Jan. 20, 2011

(54) Liquid Crystal Display Uniformity

(76) Inventor: Leonard Tsai, Mountain View, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/921,154

(22) PCT Filed: Mar. 5, 2008
(86) PCT No.: PCT/US08/55920

§ 371 Date: Sep. 5, 2010

(51) Int. Cl. G09G 5/10; G09G 3/36

(52) U.S. Cl. 345/690; 345/87

(57) ABSTRACT

In one embodiment, a system to manage luminance levels on a display device comprises a display device comprising a liquid crystal module comprising a matrix of pixels, a backlight assembly, and a plurality of drivers to drive the backlight assembly. The system further comprises a processing device coupled to the display device and comprising logic to establish a set of luminance values from a plurality of test points on the display device, determine a minimum luminance value from the set of luminance values, determine, for at least a selected one of the test points, a variance from the minimum luminance value, and use the variance to regulate a luminance level of the selected one of the test points.

### BACKGROUND

Many electronic devices include color liquid crystal displays (LCDs). Some LCDs utilize a white backlight, which is passed through at least one color filter to make different colors available to the LCD screen. Pixels on the LCD screen are arranged to groups of three, which include a red pixel, a green pixel, and a blue pixel. By managing the intensity of the red, green, and blue pixels, colors are presented on the screen.

Many LCD displays are divided into multiple regions, each of which is managed by a separate controller, alone or in combination with a separate driver. Various operational factors such as, e.g., inconsistencies between controllers, drivers and lighting elements, can result in intensity variations across the surface of the screen.

### BRIEF DESCRIPTION OF THE DRAWINGS

FIG. 1A is a schematic, front view of a LCD assembly, according to embodiments.

FIG. 1B is an exploded, side view of a LCD assembly, according to embodiments.

FIG. 2 is a schematic illustration of a display, according to embodiments.

FIG. 3 is a schematic illustration of a display illustrating sampling points, according to embodiments.

FIGS. 4-5 are flowcharts illustrating operations in a method to implement liquid crystal display uniformity, according to embodiments.

FIG. 6 is a schematic illustration of an environment in which a method to implement liquid crystal display uniformity may be implemented, according to embodiments.

FIG. 7 is a schematic illustration of a computing system, according to an embodiment.

### DETAILED DESCRIPTION

Described herein are exemplary systems and methods for enhancing the uniformity of a liquid crystal display. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

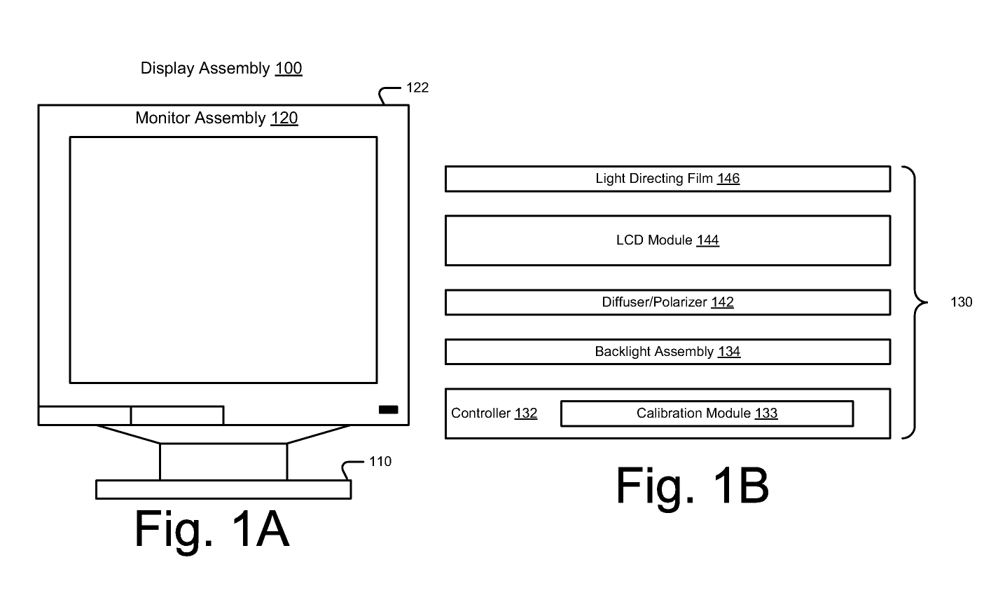

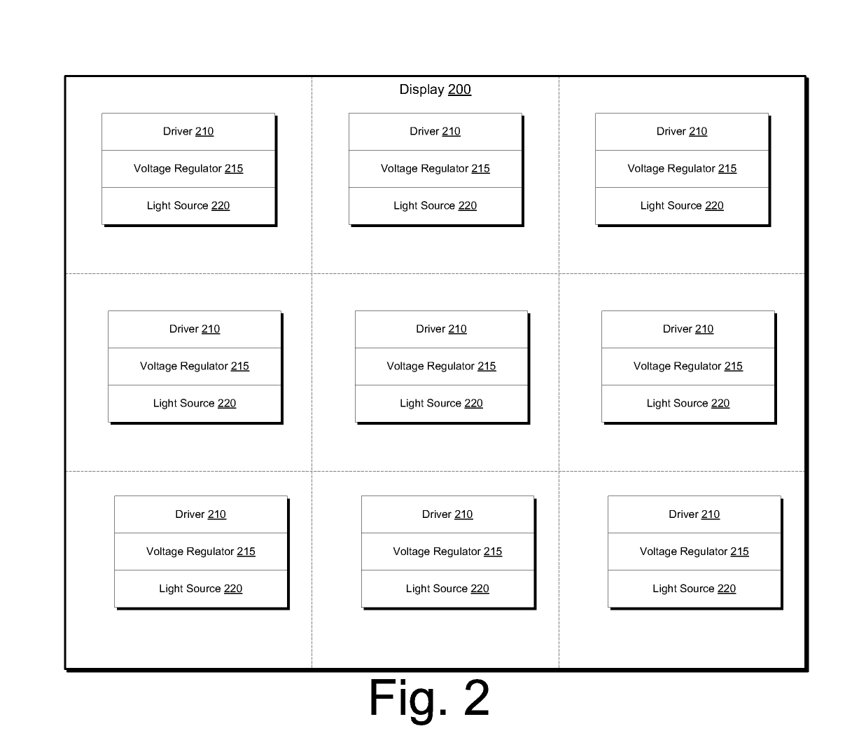

FIG. 1A is a schematic, front view of a LCD assembly, according to an embodiment, and FIG. 1B is an exploded, side view of a LCD assembly, according to an embodiment. Referring to FIG. 1A, a display assembly 100 comprises a base 110 and a monitor assembly 120 coupled to the base. Monitor assembly 120 comprises a housing 122, which houses a LCD assembly 130.

Referring to FIG. 1B, LCD assembly 130 comprises a timing controller 132, a backlight assembly 134, a diffuser 142, a LCD module 144, and a light directing film 146. Display assembly 100 may be embodied as any type of color graphics display. In one embodiment, LCD module 144 may comprise a thin film transistor (TFT) assembly. In other embodiments, the LCD module 144 may embodied as a different type of LCD, e.g., a diode matrix or another capacitively driven LCD, a digital mirror assembly, or the like.

A diffuser 142 is positioned adjacent the backlight assembly 134. In some embodiments, diffuser 142 may also act as a polarizer to polarize light emitted by the arrays of LEDs 136, 138, 140. A LCD module 144 is positioned adjacent diffuser 142. In some embodiments, LCD module may be a twisted nematic LCD, an In-plane switching LCD, or a vertical alignment (VA) LCD. In some embodiments, a light directing film 146 may be positioned adjacent the LCD to enhance the brightness of the display.

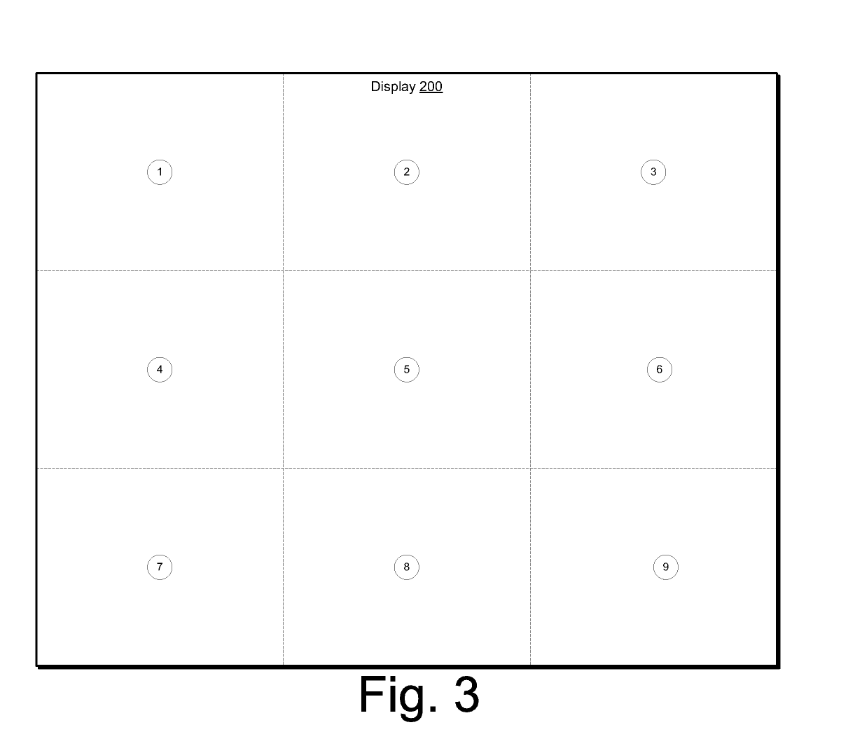

In some embodiments, a liquid crystal display device may include a calibration module 133 adapted to implement operations to improve display uniformity. Structural components of such a liquid crystal display device and associated operations will be explained with reference to FIGS. 2-7.

FIG. 2 is a schematic illustration of a display, according to embodiments. Referring to FIG. 2, in some embodiments may display 200 may be subdivided into a plurality of different sections, each of which utilizes a driver 210 and a voltage regulator 215 to drive the light source 220 for the section. In the embodiment depicted in FIG. 2, the screen is subdivided into nine different sections, each of which utilizes a driver 210, voltage regulator 215, and light source 220. In some embodiments, the light source may be implemented by one or more are arrays of light emitting diodes (LEDs), for example arrays of red, green, and blue LEDs or single white color LEDs may be used in display 200. In other embodiments the light source 200 may be implemented by and incandescent light source such as, for example, a cold cathode fluorescent light (CCFL) source or the like. In alternate embodiments the display 200 may be subdivided into a greater number or lesser number of sections. In addition, each section may be driven by a separate driver 210 and voltage regulator 215. Alternately, a driver 210 and voltage regulator 215 may output multiple signals, each of which is directed to a different light source 220 control the illumination of a different section of the display 200. The specific implementation of the display 200 is not critical to the subject matter described herein.

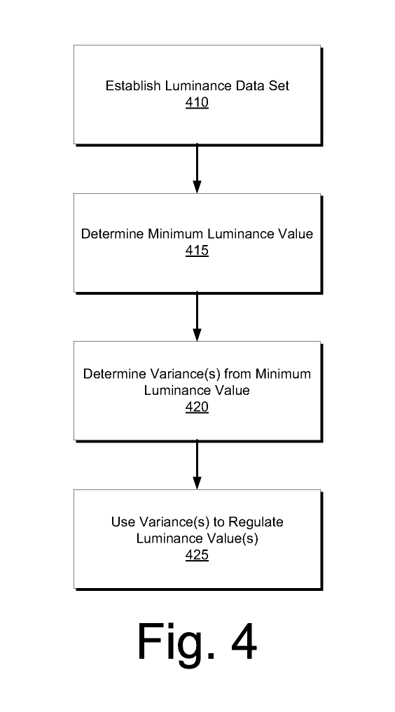

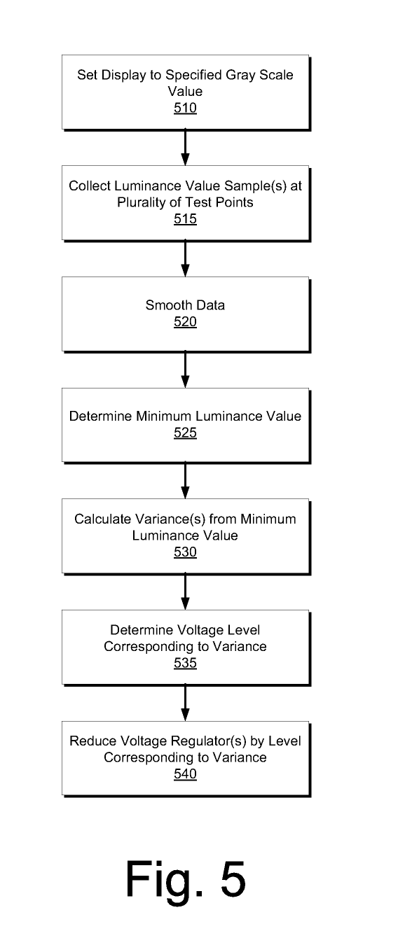

In some embodiments, a calibration process may be implemented in which luminance data is collected from each section of the display 200 and processed to generate one or more signals which may be used to enhance the uniformity of the display 200. FIG. 3 is a schematic illustration of a display illustrating sampling points, according to embodiments, and FIGS. 4-5 are flowcharts illustrating operations in a method to implement liquid crystal display uniformity, according to embodiments. Referring now to FIGS. 3 and 4, that operation 410 a luminance data set is established from a correlative test points on the display 200. In some embodiments luminance data is sampled at one or more points on the surface of each section of the display 200. FIG. 3 depicts an embodiment in which samples are taken from each of the nine sections of the display 200. In alternate embodiments, samples may be taken at multiple locations in each of the nine sections of display 200 and the resulting data may be smoothed, or averaged, to obtain a reading for the section. In addition, multiple samples may be taken at multiple points in time and the resulting data may be smoothed, or averaged, to obtain a reading for the section.

At operation 415 a minimum luminance value is determined from the luminance data set established in operation 410. In some embodiments, the luminance data collected in operation 410 are compared against one another and the minimum luminance data point is selected from the data set.

At operation 420 a variance is determined for at least a selected one of the data points in the luminance value data set resulting from the test points measured in operation 410. In some embodiments, a variance D(j) is calculated for each of the data points in the luminance value data set. In one embodiment, a variance, or delta, for each data point (j) in the data set may be determined by subtracting the minimum luminance value L(i) determined in operation 415 from the luminance value L(j) at the data point, i.e., D(j)=L(j)−L(i). The variances, or absolute values thereof, may be stored in a suitable memory location coupled to the display 200. For example, in some embodiments the controller 132 may comprise an amount of memory sufficient to store this data.

At operation 425 the variances are used to regulate a luminance level, or value, of at least one of these sections on the display 200 from which test data was collected. In some embodiments, the luminance of each section of the display 200 is reduced by an amount corresponding to the variance determined for that section. For example, the variance D(j) for each section of the display 200 may be provided to the driver 210 which drives the voltage regulator 215 and the light source 220 for that section. The driver 210 may generate a signal to reduce the output of the voltage regulator 215 by an amount corresponding to the variance D(j) for the section.

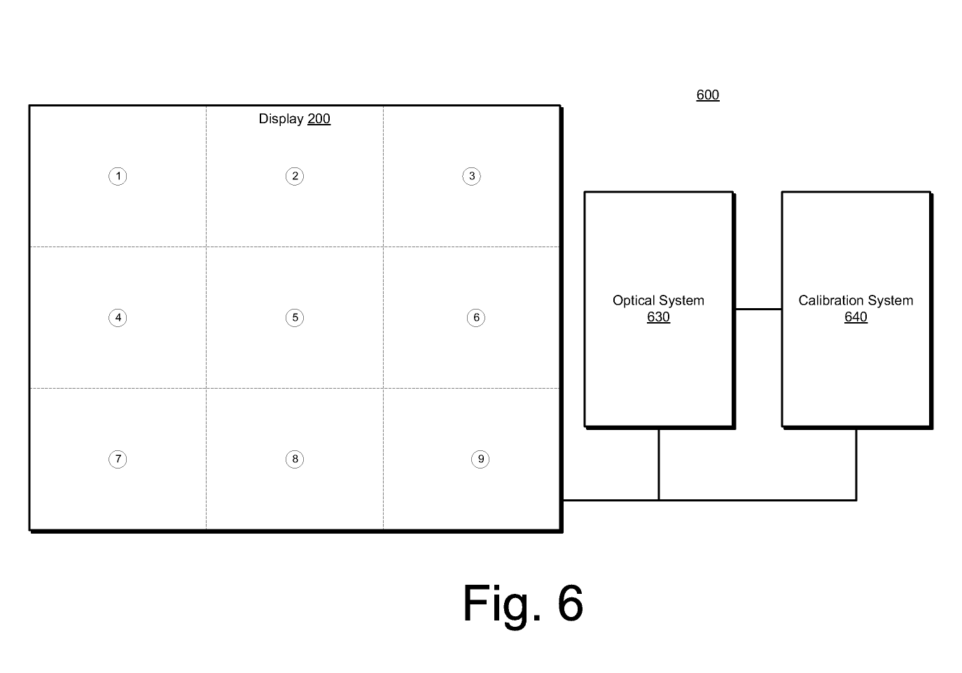

In some embodiments, the techniques described herein may be implemented as one component of a calibration process which may be conducted by a manufacturer or distributor of display 200. FIG. 5 is a flowchart illustrating operations in a method to implement liquid crystal display uniformity, according to embodiments, and FIG. 6 is a schematic illustration of an environment in which a method to implement liquid crystal display uniformity may be implemented, according to embodiments.

Referring first to FIG. 6, in one embodiment a calibration environment 600 comprises an optical system 630 and coupled to a calibration system 640, which may be coupled to a display 200. Optical system 630 may comprise one or more imaging devices such as, for example, a charge coupled device (CCD) or other imaging device which can collect luminance samples from the display 200 and generate output signals corresponding to the collected luminance samples. In some embodiments the output signals generated by optical system 630 may be input to the calibration system 640, which implements operations to manage luminance uniformity of the display 200. In other embodiments, the output of the optical system 630 may be input directly to the display 200, and particularly to the calibration module 133 of controller 132, which implements operations to manage luminance uniformity of the display 200.

In some embodiments, the operations of FIG. 5 may be implemented by one or more calibration modules such as calibration module 133, alone or in combination with logic operational in calibration system 640. Referring now to FIG. 5, at operation 510 the output of the display is set to a specified gray scale value. In some displays, grayscale values vary in a range between a value of zero, which corresponds to a minimum luminance, to a value of 255 in 8 bit system or 1023 in 10 bit system, which corresponds to a maximum luminance. In some embodiments, the display may be set to a maximum grayscale value of 255 for calibration purposes. In other embodiments calibration may be performed at grayscale values other than the maximum value, or at multiple grayscale values.

At operation 515 luminance values samples are collected at a plurality of test points on the display 200. For example, the optical system 630 may collect luminance values samples at multiple points on the display as described above with reference to FIGS. 3 and 4. As described above, data may be collected at multiple points on the surface of display 200 and at multiple points in time. At operation 520 the data collected may be smoothed, or averaged, to derive a luminance value data point corresponding to the test point. The luminance data collected may be stored as a data set in a suitable memory location

At operation 525 a minimum luminance value is determined from the data set of luminance values and at operation 530 variances from the minimum luminance value are calculated. These operations may be performed as described above with reference to FIG. 4.

At operation 535 a voltage level corresponding to the variance calculated for each section of the display 200 is determined. In some embodiments, voltage response data for the voltage regulator 215 for each section may be stored in a suitable memory location and the calibration module 133, alone or in combination with the driver 210, may access the voltage response data to determine a voltage level that corresponds to the variance measurement obtained in operation 530. An alternate embodiments, the voltage response for each voltage regulator may need to be determined using a calibration process which successively increments (or decrements) a voltage input to the voltage regulator 215 then measures a resulting output or luminance from the light source 220 and records these values in a memory location.

At operation 540 the input to the voltage regulator or 215 for each section is reduced by an amount which corresponds to the measured variance for the section.

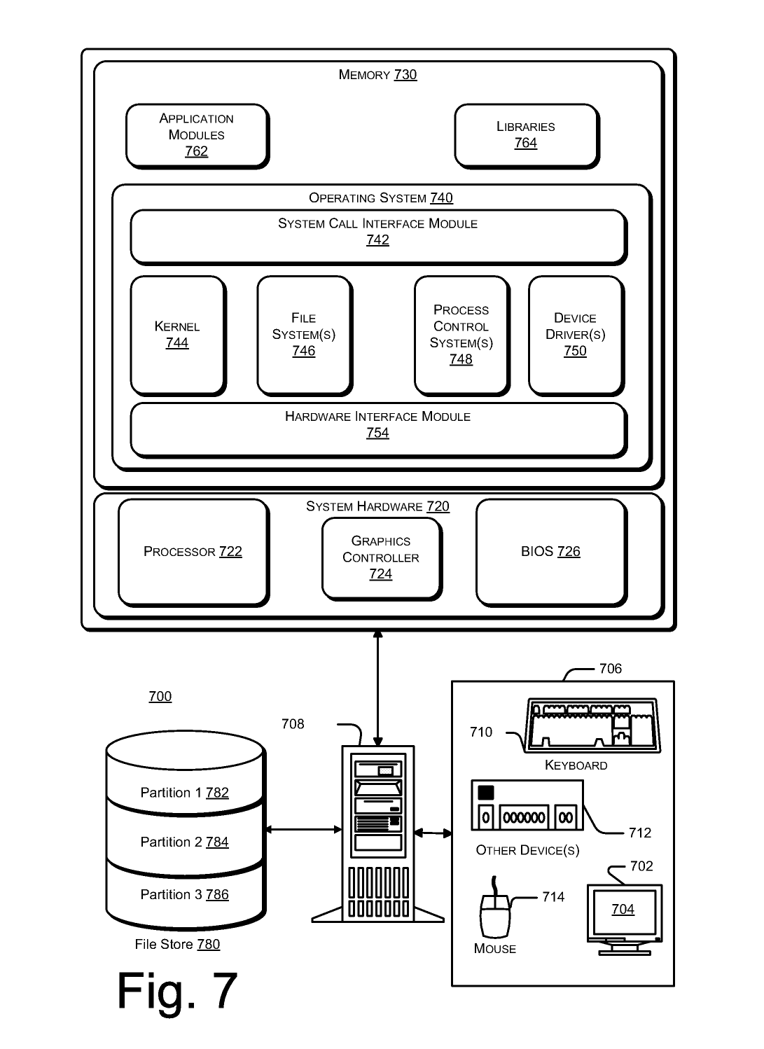

In some embodiments, a display assembly may be distributed as a component of a computer system. FIG. 7 is a schematic illustration of a computing system which includes a liquid crystal display that, according to an embodiment. The components shown in FIG. 7 are only examples, and are not intended to suggest any limitation as to the scope of the functionality of the invention; the invention is not necessarily dependent on the features shown in FIG. 7. In the illustrated embodiment, computer system 700 may be embodied as a hand-held or stationary device for accessing the Internet, a desktop PCs, notebook computer, personal digital assistant, or any other processing devices that have a basic input/output system (BIOS), software driver program or equivalent.

The computing system 700 includes a computer 708 and one or more accompanying input/output devices 706 including a display 702 having a screen 704, a keyboard 710, other I/O device(s) 712, and a mouse 714. The other device(s) 712 may include, for example, a touch screen, a voice-activated input device, a track ball, and any other device that allows the system 700 to receive input from a developer and/or a user.

The computer 708 includes system hardware 720 commonly implemented on a motherboard and at least one auxiliary circuit boards. System hardware 720 including a processor 722 and a basic input/output system (BIOS) 726. BIOS 726 may be implemented in flash memory and may comprise logic operations to boot the computer device and a power-on self-test (POST) module for performing system initialization and tests. In operation, when activation of computing system 700 begins processor 722 accesses BIOS 726 and shadows the instructions of BIOS 726, such as power-on self-test module, into operating memory. Processor 722 then executes power-on self-test operations to implement POST processing.

Graphics controller 724 may function as an adjunction processor that manages graphics and/or video operations. Graphics controller 724 may be integrated onto the motherboard of computing system 700 or may be coupled via an expansion slot on the motherboard.

Computer system 700 further includes a file store 780 communicatively connected to computer 708. File store 780 may be internal such as, e.g., one or more hard drives, or external such as, e.g., one or more external hard drives, network attached storage, or a separate storage network. In some embodiments, the file store 780 may include one or more partitions 782, 784, 786.

Memory 730 includes an operating system 740 for managing operations of computer 708. In one embodiment, operating system 740 includes a hardware interface module 754 that provides an interface to system hardware 720. In addition, operating system 740 includes a kernel 744, one or more file systems 746 that manage files used in the operation of computer 708 and a process control subsystem 748 that manages processes executing on computer 708. Operating system 740 further includes one or more device drivers 750 and a system call interface module 742 that provides an interface between the operating system 740 and one or more application modules 762 and/or libraries 764. The various device drivers 750 interface with and generally control the hardware installed in the computing system 700.

In operation, one or more application modules 762 and/or libraries 764 executing on computer 708 make calls to the system call interface module 742 to execute one or more commands on the computer's processor. The system call interface module 742 invokes the services of the file systems 746 to manage the files required by the command(s) and the process control subsystem 748 to manage the process required by the command(s). The file system(s) 746 and the process control subsystem 748, in turn, invoke the services of the hardware interface module 754 to interface with the system hardware 720. The operating system kernel 744 can be generally considered as one or more software modules that are responsible for performing many operating system functions.

The particular embodiment of operating system 740 is not critical to the subject matter described herein. Operating system 740 may be embodied as a UNIX operating system or any derivative thereof (e.g., Linux, Solaris, etc.) or as a Windows® brand operating system or another operating system.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. A method to manage luminance levels on a display device, comprising:
establishing a set of luminance values from a plurality of test points on the display device;
determining a minimum luminance value from the set of luminance values;
determining, for at least a selected one of the test points, a variance from the minimum luminance value; and
using the variance to regulate a luminance level of the selected one of the test points.

2. The method of claim 1, wherein establishing a set of luminance values from a plurality of test points on the display device comprises measuring a luminance value of a specified gray level at the plurality of test points on the display device.

3. The method of claim 2, wherein:
the specified gray level corresponds to a maximum luminance value for the display device; and
establishing a set of luminance values from a plurality of test points on the display device comprises collecting a plurality of samples from the plurality of test points and applying a smoothing routine to the plurality of samples.

4. The method of claim 1, wherein determining, for at least a selected one of the test points, a variance from the minimum luminance value comprises subtracting the minimum variance value from the variance value for the selected one of the test points.

5. The method of claim 1, wherein using the variance to regulate a luminance level of the selected one of the test points comprises:
determining a voltage level for a voltage regulator corresponding to the variance; and
reducing the output voltage of the voltage by an amount corresponding to the variance.

6. The method of claim 1, wherein establishing a set of luminance values from a plurality of test points on the display device comprises determining an average of one or more test points illuminated by a common voltage regulator.

7. A display device, comprising:
a liquid crystal module comprising a matrix of pixels;
a backlight assembly;
a plurality of drivers to drive the backlight assembly; and
a controller comprising logic to:
receive a set of luminance values from a plurality of test points on the display device;
determine a minimum luminance value from the set of luminance values;
determine, for at least a selected one of the test points, a variance from the minimum luminance value; and
use the variance to regulate a luminance level of the selected one of the test points.

8. The display device of claim 7, further comprising logic to receive a luminance value of a specified gray level at the plurality of test points on the display device.

9. The display device of claim 8, wherein the specified gray level corresponds to a maximum luminance value for the display device; and
further comprising logic to receive a plurality of samples from the plurality of test points and applying a smoothing routine to the plurality of samples.

10. The display device of claim 7, further comprising logic to subtract the minimum variance value from the variance value for the selected one of the test points.

11. The display device of claim 7, further comprising logic to:
determine a voltage level for a voltage regulator corresponding to the variance; and
reduce the output voltage of the voltage by an amount corresponding to the variance.

12. The display device of claim 7, further comprising logic to determine an average of one or more test points illuminated by a common voltage regulator.

13. A system to manage luminance levels on a display device, comprising:
a display device, comprising:
a liquid crystal module comprising a matrix of pixels;
a backlight assembly; and
a plurality of drivers to drive the backlight assembly; and
a processing device coupled to the display device and comprising logic to:
establish a set of luminance values from a plurality of test points on the display device;
determine a minimum luminance value from the set of luminance values;
determine, for at least a selected one of the test points, a variance from the minimum luminance value; and
use the variance to regulate a luminance level of the selected one of the test points.

14. The system of claim 13, further comprising logic to measure a luminance value of a specified gray level at the plurality of test points on the display device.

15. The system of claim 14, wherein the specified gray level corresponds to a maximum luminance value for the display device; and
further comprising logic to collect a plurality of samples from the plurality of test points and applying a smoothing routine to the plurality of samples.

16. The system of claim 13, further comprising logic to subtract the minimum variance value from the variance value for the selected one of the test points.

17. The system of claim 13, further comprising logic to:
determine a voltage level for a voltage regulator corresponding to the variance; and
reduce the output voltage of the voltage by an amount corresponding to the variance.

18. The system of claim 13, further comprising logic to determine an average of one or more test points illuminated by a common voltage regulator.
